(19) United States
(12) Patent Application Publication
(10) Pub. No.: US 2008/0061258 A1
(43) Pub. Date: Mar. 13, 2008

(54) Anti-Tamper Ring For Beer Keg

(76) Inventor: Stephen J. Grimwade, Huntingdon (GB)

Correspondence Address: Levy & Grandinetti, 1725 K Street, N.W., Suite 408, Washington, DC, 20006-1419, US

(21) Appl. No.: 11/596,986

(22) PCT Filed: May 20, 2005
(86) PCT No.: PCT/IB05/01374

§ 371 Date: Sep. 10, 2007

(30) Foreign Application Priority Data
May 20, 2004 (GB) 0411287.6

(51) Int. Cl. B67D 1/08

(52) U.S. Cl. 251/90; 222/105

(57) ABSTRACT

A valve assembly is disclosed for filling a bag with beer where the bag is contained in a beer keg having an aperture. The valve assembly has a valve body assembly adapted to be secured in the keg aperture. The valve assembly has an anti-tamper ring that has a plurality of tongue protrusions for mating reception with a locating groove or indentations in the neck of the a valve assembly for an alcohol beverage container. The anti-tamper ring also closes a vent opening of an air relief passageway that extends through the valve body assembly.

### FIELD OF THE INVENTION

The present invention relates to an anti-tamper ring for use with or as part of a valve assembly of an alcohol beverage container.

### BACKGROUND OF THE INVENTION

It is known to contain alcohol, such as wine in bags contained in a cardboard type container. Further, it is known to use a bag inserted into a keg for storing beer in the bag. In the case of a beer keg, pressure is applied to the bag to dispense the beer from the bag and out of the keg through a valve body assembly. Further, the bag is inserted into the keg container prior to the beer being filled into the bag through the valve body assembly.

The use of an anti-tamper ring is known for supporting the lower side of the valve body assembly and preventing removal of the valve body assembly from the keg. The anti-tamper ring has in inside ring dimension smaller than the outside diameter of a valve body so that the ring is press fitted against the valve body. Further, the anti-tamper ring has been used to close a relief airway through the valve body assembly. When the anti-tamper ring is displaced from the relief airway or removed from the container, pressurized air between the bag and the keg inner liner wall safely bleeds through the relief airway. However, during press fitting assembly of the anti-tamper ring with the valve body assembly it is often difficult to fully push the anti-tamper ring into a final resting position. As a consequence, the vertical clearance at the neck of the valve assembly may be insufficient to permit the locating and connecting of the keg adapter onto the head of the valve assembly. In some instances it may be possible that the anti-tamper ring is not properly seated with the valve assembly to the extent that the relief airway is not closed allowing the escape of pressurized air from between the bag and the keg inner wall. Accordingly, there is a need for an anti-tamper ring that is not subject to these problems.

### SUMMARY OF THE INVENTION

The present invention relates to the use of an anti-tamper ring that has a plurality of tongue protrusions for mating reception with a locating groove or, indentations, in the neck of a valve assembly for an alcohol beverage container. Advantage is found with the use of the tongue portions and the locating groove on the head of the valve assembly as the two parts are positively located relative to each other while, where desirable, limiting or reducing those surface portions of the anti-tamper ring that press against the neck of the valve to the tongue portions. This reduces the occurrence of improper seating of the anti-tamper ring thereby permitting effective connection of a tap adapter onto the neck of the valve assembly.

The valve assembly has a plurality of valve controlled passageways for controlling pressure within the container and for controlling the flow of the alcohol beverage into and out of the bag. The valve body assembly has at least one recessed indentation positioned outside the container when the valve body assembly is secured in the aperture. The anti-tamper ring has an inner ring edge portion having a plurality of spaced apart locking tongue portions projecting inwardly of the inner ring edge portion. The tongue portions engage, in mating securing relation, the at least one recessed indentation.

In one embodiment, the at least one recessed indentation comprises an annular groove extending about the valve body assembly. Alternatively, the may be an indentation for each tongue portion. In the one embodiment, three tongue portions are evenly spaced around the inner edge ring portion of the anti-tamper ring. It should be understood that in alternative embodiments 2 and 4 or more tongue portions may be utilized.

In one embodiment, the valve body assembly further includes an air relief passageway extending through the valve body assembly which when open vents pressurized air from the container. The anti-tamper ring is utilized in this one embodiment to close the air relief passageway when the tongues of the anti-tamper ring engage the at least one recessed indentation.

In accordance with an aspect of the present invention there is provided a valve assembly adapted for filling a bag with an alcohol beverage where the bag is contained in a container having an aperture. The valve assembly comprises a valve body assembly adapted to be secured in the aperture. The valve body assembly has a plurality of valve controlled passageways for controlling pressure within the container and for controlling the flow of the alcohol beverage into and out of the bag. The valve body assembly has at least one recessed indentation positioned outside the container when the valve body assembly is secured in the aperture. An anti-tamper ring is adapted to be secured with the valve body assembly in covering relation with an outside portion of the container. The anti-tamper ring has an inner ring edge portion having a plurality of spaced apart locking tongue portions projecting inwardly of the inner ring edge portion. The tongue portions engage, in mating securing relation, the at least one recessed indentation.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus;

FIG. 3 is a broken away perspective view of the keg showing the valve and spear assembly mounted within the keg;

FIG. 4 is a sectional side view of the valve and spear assembly as shown in FIG. 3;

FIG. 5 is a perspective view of the valve assembly including the anti-tamper ring; and,

FIG. 6 is a perspective view of the anti-tamper ring.

### DETAILED DESCRIPTION OF THE INVENTION

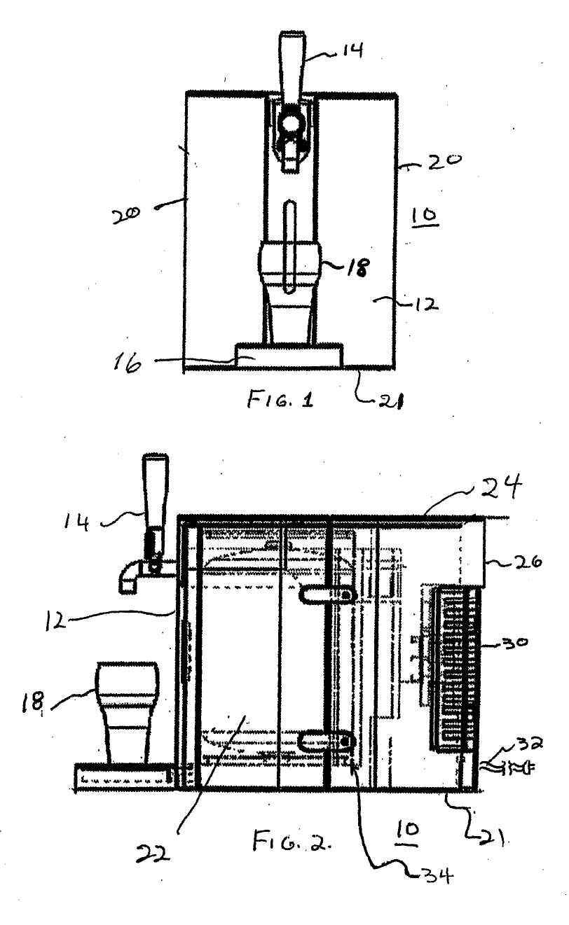

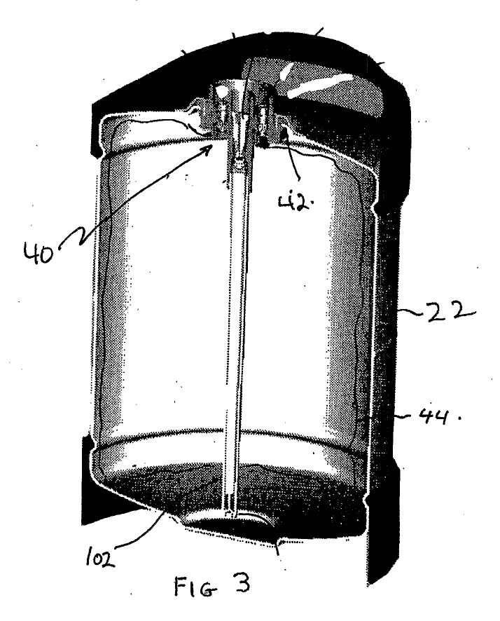

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top. The front wall 12 is an extension of two pivoting side walls 20 which may be moved between closed and open positions to allow the container or, in the embodiment shown, keg 22 (see FIG. 2 in broken lines) to be inserted into the housing of the home beer dispensing apparatus 10.

The housing of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the unit 10. Alternatively, a 12 Volt DC supply input may be used.

The dispensing apparatus 10 has a cooling system 34 located behind and below keg 22 that is adapted to cool beer in keg 22 when keg 22 is placed into dispensing apparatus 10

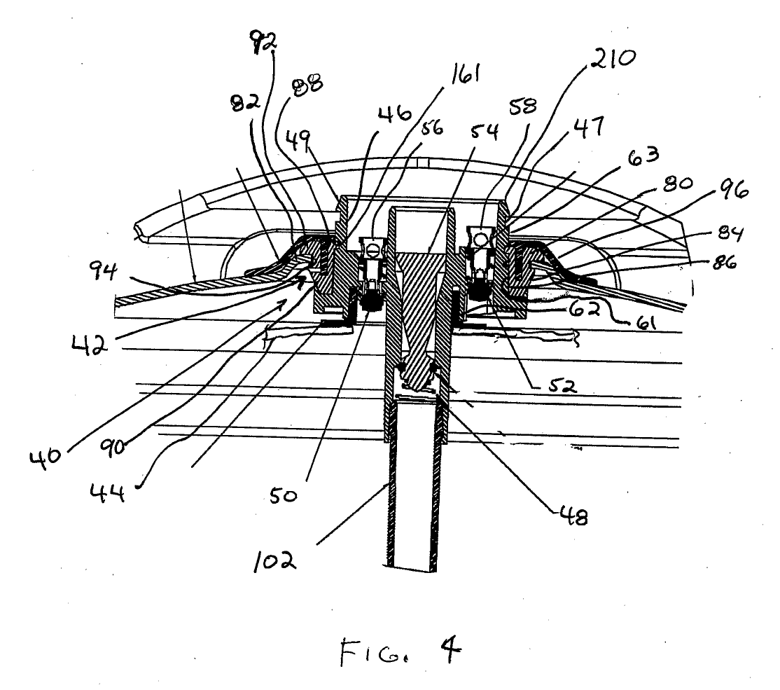

Referring now to FIGS. 3 and 4, the valve assembly 40 and spear 102 are shown.

The valve assembly 40 is adapted to fit into a raised collar aperture 42 of keg 22. The valve assembly 40 has an annular shaped central valve body assembly 46 that is secured in the aperture 42. The valve body assembly or valve body 46 has an annular groove 47 and flange 49 that is adapted to extend above the keg 22 for mating with a tap dispensing adapter (not shown) connected to tap 14 (see FIGS. 1 and 2).

In the embodiment shown, the valve body 46 has a first passageway 48, a second passageway 50, and a third passageway 52 spaced apart from each other and extending through the valve body 46. The first passageway 48 is centrally disposed or located within the valve body 46 and the second and third passageways 50, and 52 are spaced radially of the first central passageway 48.

The valve assembly 40 includes a first valve 54, a second valve 56 and a third valve 58. The first valve 54 is seated in the first passageway 48 for controlling the flow of the beverage or beer through the first passageway 48 into and out of the bag 44.

The second valve 56 is seated in the second passageway 50 for controlling the flow of gas such as carbon dioxide through the second passageway 50 into and out of the bag 44.

The third valve 58 is seated in the third passageway 52 and controls the flow of gas through the third passageway 52 into and out of the keg 22 exterior to the bag 44.

The valve body 46 has an annular recessed groove 62 recessed in an inner wall of the valve body 46. The inner wall is positioned within the keg 22. The recessed grooves 62 is adapted for receiving the neck of bag 44 in press fit relation therewith. The annular recessed groove 62 has a diameter that surrounds the first and second passageways 48 and 50. The third passageway 52 is located outside of the diameter of the recessed groove 62 and as a result, the third passageway 52 is located outside of the bag 44.

The keg 22 has a raised collar ring flange 82 which defines the keg aperture 42 in which the valve body may be secured. The valve body 46 has an outer peripheral wall 63 with a recessed groove 61 extending around the outer wall 63. The valve assembly 40 has an intermediate collar ring or bung 80 that is adapted to seat the valve body 46 within the raised collar aperture 42. The intermediate collar ring 80 has inner and outer walls 84, 86. The inner wall 84 has flange 88 extending inwardly thereof that is adapted to fit into the recessed groove 61 of the outer wall 63 of the valve body 46. The outer wall 86 of the intermediate ring 80 has a resilient barb 90 and a locking flange 92 spaced from the barb 90 so as to define an outer locating groove 94 into which the collar flange 82 of the keg 22 is held. The barb 90 is adapted to pass through the aperture 42 and spring back into locking engagement with the collar flange 82 so as to lock the valve assembly 40 in place. Special tools are required to remove the valve assembly 40 and the intermediate collar ring 80 from the collar flange 82 of the keg 22 once the keg 22 is returned to the brewery for refilling.

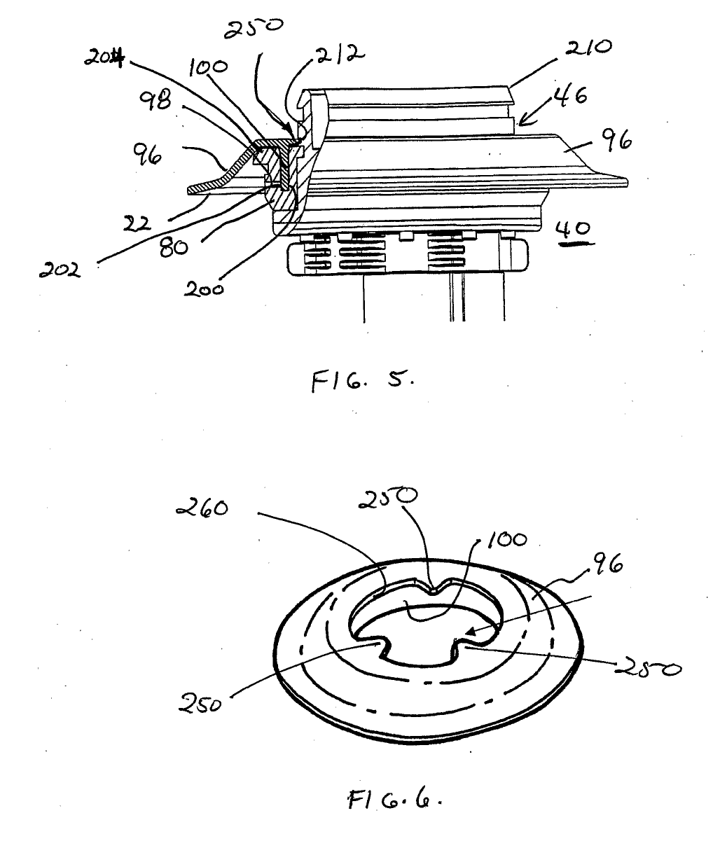

In order to insure that the contents of the keg 22 have not been tampered with, the keg 22 has an anti-tamper ring 96 as best seen in FIGS. 4, 5, and 6. The anti-tamper ring 96 overlays the intermediate collar ring 80, a portion of the keg 22 and a portion of the valve body 46. Visual inspection of the anti-tamper ring 96 permits a user to readily identify if the anti-tamper ring has been displaced.

The intermediate collar ring 80 is adapted to be secured in the aperture 42 as previously described. The intermediate collar ring 80 has an outer surface 204 with a downwardly depending recessed annular groove 200. The intermediate collar ring has an air relief passageway 98 extending therethrough. Passageway 98, when open, vents pressurized air from keg 22 to atmosphere. The air relief passageway 98 has a vent opening 202 in air flow communication with the annular groove 200.

The anti-tamper ring 96 has a downwardly depending flange portion 100 that is inserted into an annular groove 200 of the outward facing surface 204 of the intermediate collar ring 80. In the event the anti-tamper ring 96 is removed from the keg 22, vent aperture 98 is open and the contents or any pressure within the keg 22 is released. Further, as a pressure relief feature, the anti-tamper ring 96 may be designed to release from aperture 98 when pressure in keg 22 exceeds a predetermined valve so as to vent pressurized air through aperture 98.

The valve body 46 is adapted to be secured within the intermediate collar ring 80 as previously described. The valve body 46 has a neck portion 210 that extends outwardly of the intermediate collar ring 80. The neck portion 210 has an annular groove 212 extending about the neck portion. The annular groove 212 receives in mating securing engagement locking tongue portions 250 of the anti-tamper ring 96. The locking tongue portions 250 secure the anti-tamper ring in a seated position with the valve body 46 so as to cover the intermediate collar ring 80 and an outside portion of the keg 22. The anti-tamper ring 96 has an inner ring edge portion 260 from which the evenly spaced apart locking tongue portions 250 project inwardly. The tongue portions 250 flex as the anti-tamper ring 96 is pushed over the neck portion 210 of the valve body 46 and spring into locking engagement with the annular groove 212 of the valve body. In the embodiment illustrated, the inner ring edge portion 260 has an inside diameter that is slightly larger than the outside diameter of the neck portion 210 of the valve body. Consequently, the press fitting of the anti-tamper ring 96 with the valve body is limited to the contact with the tongue portions 250.

What is claimed is:

1. A valve assembly adapted for filling a bag with an alcohol beverage where the bag is contained in a container having an aperture, the valve assembly comprising:
a valve body assembly adapted to be secured in the aperture, the valve body assembly having a plurality of valve controlled passageways for controlling pressure within the container and for controlling the flow of the alcohol beverage into and out of the bag, the valve body assembly having at least one recessed indentation positioned outside the container when the valve body assembly is secured in the aperture; and,
an anti-tamper ring adapted to be secured with the valve body assembly in covering relation with an outside portion of the container, the anti-tamper ring having an inner ring edge portion having a plurality of spaced apart locking tongue portions projecting inwardly of the inner ring edge portion, and the tongue portions engaging, in mating securing relation, the at least one recessed indentation.

2. The valve assembly of claim 1 wherein the at least one indentation comprises an annular groove extending about the valve body assembly.

3. The valve assembly of claim 1 wherein the valve body assembly further includes an air relief passageway extending through the valve body assembly which when open vents pressurized air from the container, and the anti-tamper ring closing the air relief passageway when the tongues of the anti-tamper ring engage the at least one recessed indentation.

4. The valve assembly of claim 3 wherein the at least one indentation comprises a first annular groove extending about the valve body assembly.

5. The valve assembly of claim 4 wherein the container has a collar flange defining the aperture, and the valve body assembly further comprising:
a central valve body portion having an outer wall portion with a second annular groove; and,
an intermediate collar ring having inner and outer walls, the intermediate collar ring having the air relief passageway extending therethrough, the inner wall of the intermediate ring having a flange extending inwardly thereof adapted to fit into the second annular groove of the outer wall of the central valve body, and the outer wall of the intermediate ring having a resilient barb and spaced locking flange defining an outer groove into which the collar flange of the container is held, and the barb passing through the aperture and springing back into locking engagement with the collar flange to lock the valve assembly in place.

6. A valve assembly adapted for filling a bag with an alcohol beverage where the bag is contained in a container having an aperture, the valve assembly comprising:
an intermediate collar ring adapted to be secured in the aperture, the intermediate collar ring having a downwardly depending first recessed annular groove and an air relief passageway extending through the intermediate collar ring, the air relief passageway having a vent opening in the first recessed annular groove;
a valve body adapted to be secured within the intermediate collar ring, the valve body having a plurality of valve controlled passageways for controlling pressure within the container and for controlling the flow of the alcohol beverage into and out of the bag, the valve body having a neck portion that extends outwardly of the intermediate collar ring, the neck portion having at least one recessed indentation positioned outside the container when the valve body assembly is secured in the intermediate collar ring; and,
an anti-tamper ring adapted to be secured with the valve body and the intermediate collar ring in covering relation with an outside portion of the container, the anti-tamper ring having an inner ring edge portion having a plurality of spaced apart locking tongue portions projecting inwardly of the inner ring edge portion, the tongue portions engaging, in mating securing relation, the at least one recessed indentation, and the anti-tamper ring having a downwardly depending annular flange adapted to engage in mating relation the first recessed annular groove of the intermediate collar ring and thereby close the vent opening.

7. The valve assembly of claim 6 wherein the at least one indentation comprises a second annular groove extending about the neck of the valve body.

8. The valve assembly of claim 6 wherein the container has a collar flange defining the aperture, and the valve body has an outer wall portion with a third recessed annular groove; and the intermediate collar ring has inner and outer walls, the inner wall of the intermediate ring having a flange extending inwardly thereof adapted to fit into the third recessed annular groove of the outer wall of the central valve body, and the outer wall of the intermediate ring having a resilient barb and spaced locking flange defining an outer groove into which the collar flange of the container is held, and the barb passing through the aperture and springing back into locking engagement with the collar flange to lock the valve assembly in place.

9. An alcohol beverage dispensing apparatus comprising:
a keg having an aperture;
a bag contained in the keg for containing an alcohol beverage; and,
a valve assembly comprising:
a valve body assembly adapted to be secured in the aperture, the valve body assembly having a plurality of valve controlled passageways for controlling pressure within the container and for controlling the flow of the alcohol beverage into and out of the bag, the valve body assembly having at least one recessed indentation positioned outside the container when the valve body assembly is secured in the aperture; and,
an anti-tamper ring adapted to be secured with the valve body assembly in covering relation with an outside portion of the container, the anti-tamper ring having an inner ring edge portion having a plurality of spaced apart locking tongue portions projecting inwardly of the inner ring edge portion, and the tongue portions engaging, in mating securing relation, the at least one recessed indentation.

10. The valve assembly of claim 9 wherein the at least one indentation comprises an annular groove extending about the valve body assembly.

11. The valve assembly of claim 9 wherein the valve body assembly further includes an air relief passageway extending through the valve body assembly which when open vents pressurized air from the container, and the anti-tamper ring closing the air relief passageway when the tongues of the anti-tamper ring engage the at least one recessed indentation.

12. The valve assembly of claim 11 wherein the at least one indentation comprises an annular groove extending about the valve body assembly.
